(19) United States
(12) Patent Application Publication
(10) Pub. No.: US 2005/0059392 A1
(43) Pub. Date: Mar. 17, 2005

(54) Apparatus, and associated method, for facilitating determination of mobile roaming relationship

(76) Inventor: Gerald Winton Lankford, Waterloo (CA)

Correspondence Address: David B. Cochran, Esq.;JONES DAY, North Point, 901 Lakeside Ave, Cleveland, OH, 44114, US

(21) Appl. No.: 10/663,598

(22) Filed: Sep. 16, 2003

(51) Int. Cl. H04Q 7/20

(52) U.S. Cl. 455/432.1

(57) ABSTRACT

Apparatus, and an associated method, for forming a roaming network list that identifies roaming arrangements between network operators of a cellular, or other mobile, communication system in which different networks are operated by different network operators. The roaming network list is dynamically created through detection, at a detector, of positional information of mobile nodes that operate pursuant to communications with different ones of the networks of the communication system. An associator associates mobile nodes, by their home networks, with networks with which the mobile nodes are capable of communicating. Associations made by the associator are used to form the roaming network list. Subsequent access to the list permits the roaming arrangements, dynamically determined, to be ascertained.

The present invention relates generally to a manner by which to obtain roaming network information used to form a roaming network list in a multi-network mobile communication system. More particularly, the present invention relates to apparatus, and an associated method, by which to automatically and dynamically create the roaming network list. The roaming network list identifies networks with which mobile nodes, associated with particular home-networks, are operable.

### BACKGROUND

Availability of a communication system through which to communicate data is necessary in modern society. Many aspects of both business and leisure activities require the communication of data pursuant to the effectuation of a communication service. Data that is communicated during the effectuation of a communication service is originated at a communication source and delivered to a communication destination.

A communication system includes, at a minimum, a set of communication stations. The set includes at least a first communication station to which data that is sourced at the communication source is provided. The first communication station forms a sending station that operates to send data therefrom. The set of communication stations includes at least a second communication station that forms a receiving station. The second communication station is coupled to, or forms, the communication destination. The data sent by the first communication station is communicated upon a communication channel to the second communication station, thereby to effectuate the communication of the data, and the communication service, therebetween.

Communication services include both one-way communication services and two-way communication services. One-way communication services are mono-directional. That is to say, data flows in a single direction, from the sending station to the receiving station. Two-way communication services are possible when communication stations of a set of communication stations are capable of both sending and receiving data. That is to say, communication stations capable of transmitting and receiving data permit the effectuation of two-way communication services.

As technological advancements permit, new types of communication systems have been developed and implemented. Technological advancements, when implemented in a communication system, generally permit the data throughput rate at which data is communicated to be increased, at increased levels of accuracy, and over greater distances. Communication performance is measured in terms of a performance criteria, such as baud rate, bit error rate (BER), etc.

A radio communication system is an exemplary type of communication system. In a radio communication system, communication channels upon which data is communicated between communication stations are defined upon radio links extending between the communication stations. Wireline connections, conventionally required to interconnect the communication stations, and upon which to define communication channels in a conventional, wireline communication system, are obviated. Because a wireline connection is not required, radio communication systems provide various advantages over their wireline counterparts. Mobility of communications is a significant advantage that can be provided by a radio communication system.

Technological advancements that are incorporated into new and existing types of communication systems include both advancements in communication technologies and advancements in processing technologies. That is to say, advancements in processing technologies, as well as advancements in communication technologies, are incorporated into new, and existing, communication systems. Technological advancements pertaining to data processing generally provide for increased amounts of data to be processed at quicker rates. And, modern data processing techniques permit large amounts of data to be stored and to be processed.

Radio communication systems, e.g., are regularly used to transport data that is subsequently processed through the use of data processing techniques. Communication devices, and systems in which the communication devices are used; are available by which to perform various data processing operations and communication services. Additional communication services, and associated applications that implement new data processing and communication technologies, shall likely continue to be developed and implemented in the future.

A cellular communication system is a type of radio communication system that provides for voice and for data communication services. A cellular communication system is a multi-user system, permitting multiple access by significant numbers of users. Cellular communication systems are popularly utilized and have achieved high penetration levels in many parts of the world. Network infrastructures of such cellular communication systems have been employed to encompass significant portions of the populated areas of the world. Successive generations of cellular communication systems have been deployed, sometimes overlayed upon common geographical areas. Different networks are operated by different network operators.

Access to a cellular communication system is generally provided pursuant to a service subscription thereto. A user utilizes a mobile station, also known as a mobile node, by which to communicate with the network infrastructure of the cellular communication system. The mobile node is associated with a particular network, referred to as the home network of the mobile node. Due to the inherent mobility of the mobile node, the mobile node might travel, i.e., roam, beyond the area encompassed by the home network of the mobile node. To permit continued operation of the mobile node, the mobile node must be capable of communicating with the network infrastructure of the network into whose area the mobile node roams.

So-called roaming agreements are agreements into which operators of different networks, or groups of networks, enter. Pursuant to a roaming agreement, a mobile node, positioned in an area encompassed by a network other than the home network of the mobile node, the mobile node is permitted access to communicate by way of the network infrastructure of the area into which the mobile node has roamed. Authentication, attachment, data routing, and billing procedures, amongst others, are provided pursuant to the roaming agreement.

Roaming agreements tend, however, not always to be static. That is to say, roaming agreements between operators are sometimes terminated and new agreements into between other network operators. And, when a mobile node roams into a geographical area on separate occasions, the mobile node might well be capable of accessing the network infrastructure operated by a first operator on one occasion and to access network infrastructure operated by another operator during another occasion due to termination of one roaming agreement and creation of another roaming agreement.

A network operator sometimes publishes lists that identify other operators with whom the network operator has roaming agreements. The tables are published, for instance, on a website supported by the network operator. A user of a mobile node accesses the website to view the roaming list or table posted thereon. However, because the network operator might well enter into new agreements and terminate old agreements, the roaming table might not accurately identify the existing roaming arrangements at the time when the user of the mobile node accesses the published list or table. The user is then at risk of inappropriately relying upon the availability of communications, using the mobile node, during subsequent travel into a roaming area. Or, the user, alternately, is at risk making alternate communication arrangements and utilizing the mobile node, even though the mobile node is permitted roaming operation into a roaming area into which the user subsequently travels.

A manner by which better to identify, accurately and timely, the roaming agreements with a network operator is therefore needed.

It is in light of this background information related to roaming of a mobile node in a communication system that the significant improvements of the present invention have evolved.

### SUMMARY OF THE INVENTION

In accordance with an aspect of the invention, an improvement of apparatus for facilitating communication of a mobile node when roaming beyond a home-network portion of a network part of a communication system associated therewith is provided in a radio communication system having at least a first mobile node operable to communicate with the network part, the network part having a first network portion and at least a second network portion, the first network portion operated by a first network operator and the at least the second network portion operated by at least a second network operator, a selected one of the first network portion and the at least the second network portion forming the home-network portion associated with the mobile node. The apparatus comprises a detector adapted to receive positional information associated with the mobile node, the positional information communicated by the mobile node to the network part at selected times when the mobile node communicates with the network part, said detector for detecting values of the positional information and for forming indications of the values of the positional information, an associator coupled to said detector to receive the indications formed by said detector of the values of the positional information, said associator for associating positioning of the mobile node together with one of the first and at least second network portions, respectively, to which the positional information is communicated, thereby to indicate, if the one of the network portions, with which the positioning information indicates the mobile node to be associated, is other than the home-network portion, and a storage element coupled to said associator, said storage element for storing values representative of associations formed by said associator, the values together forming a roaming network table indicating with which of the network portions the mobile node is capable of communicating.

According to another aspect of the invention, an improvement of a method for facilitating communication of a mobile node when roaming beyond a home-network portion of a communication system associated therewith is provided in a method of communicating in a radio communication system having at least a first mobile node operable to communicate with a network part, the network part having a first network portion and at least a second network portion, the first network portion operated by a first network operator and the at least the second network portion operated by at least a second network operator, a selected one of the first network portion and the at least the second network portion forming the home-network portion associated with the mobile node. The improvement in the method comprises detecting values of positional information, the positional information associated with the mobile node and communicated by the mobile node to the network part at selected times when the mobile node communicates with the network part, associating positioning of the mobile node together with one of the first and at least second network portions, respectively, to which the positional information is communicated, thereby to indicate, if the one of the network portions with which the positioning information indicates the mobile node to be associated, is other than the home network portion, and forming a roaming network table indicating with which of the network portions that the mobile node is capable of communicating responsive to associations formed during said operation of associating.

A more complete appreciation of aspects of the present invention and the scope thereof can be obtained from the accompanying drawings that are briefly summarized below, the following descriptions of the presently-preferred embodiments of the invention, and the appended claims.

### BRIEF DESCRIPTION OF THE DRAWINGS

FIG. 1 illustrates a functional block diagram of a radio communication system in which an embodiment of the present invention is operable.

FIG. 2 illustrates a message sequence diagram representative of signaling generated during operation of an embodiment of the present invention that forms part of the communication system shown in FIG. 1.

FIG. 3 illustrates an exemplary roaming network table constructed pursuant to operation of an embodiment of the present invention.

FIG. 4 illustrates a method flow diagram listing the method steps of a method of operation of an embodiment of the present invention.

### DETAILED DESCRIPTION

Apparatus and an associated method by which to obtain roaming network information that identifies networks permitting roaming of a mobile node, associated with a particular home network, are provided.

Through operation of an embodiment of the present invention, a manner is provided by which automatically and dynamically to create a roaming network list. The list identifies networks with which mobile nodes, associated with particular home networks, are operable.

In one aspect of the present invention, the list is created by detecting with which network a roaming mobile node is permitted to communicate. Communication of a plurality of mobile nodes, and their respective connections, are monitored and information derived there from, is used to create the list. Up-to-date roaming information is maintained in the roaming network list. The information is time-dated, and is removed, or relied upon less, as the information ages. The list is formed at a service center and is available for subsequent review. Subsequent access to the roaming network list provides an accurate indication of with which network, and in which area corresponding thereto, that the mobile node is capable of communicating when the mobile node travels beyond its home network.

The mobile node is identified by an identifier. And, the identifier is communicated during its operation to communicate with a network part of a cellular, or other radio, communication system. The identifier is communicated by the mobile node to the network part. And, the identifier is used, together with positional information in the formation of the roaming network list. The identifier that identifies the mobile node indicates, for instance, the network that is the home network associated with the mobile node. And, positioning of the mobile node is identified, at least in terms of the network with which the mobile node communicates. The identifier of the mobile node that identifies the home network of the mobile node together with the positional information indicates a relationship between the mobile node and the network with which the mobile node is communicating. This relationship indicates that a roaming agreement is in existence between the home network associated with the mobile node and the network with which the mobile node is communicating. Entry of such an indication into a roaming network list indicates such a relationship.

The identifier communicated by the mobile node forms, for instance, an IMSI (International Mobile Subscriber Identity) number that includes a mobile network code (MNC) and a mobile country code (MCC). An associator associates the positional information together with the identifier that identifies the mobile node, thereby to identify the network with which the mobile node of a particular home network is capable of operation when roaming therein. And, indicia associated with the association is used to populate a roaming network list. The roaming network list is formed at a storage element embodied at, for instance, at a service center.

The roaming network list also includes a time-stamp that identifies the time at which the association is made such as by identifying the time at which the roaming network list entry is formed.

The identifier is communicated to the network pursuant to registration procedures by which the mobile node registers itself with the network. Registration procedures are performed, amongst other times, when a mobile node is initially powered-on, when the mobile node enters a new network, or portion of a network, and at selected intervals during its operation. And, in a further embodiment, message header portions of data packets or frames that are communicated by a mobile node each include the identifier. Thereby, the identifier that identifies the mobile node is provided to the network with which the mobile node communicates at frequent intervals.

Entries in the roaming network list are selectably deleted when the entry ages beyond a selected age. That is to say, when the time-stamp associated with an entry is aged beyond a selected age, the entry is removed, or otherwise given less reliance as to the present state of the roaming capabilities identified by the entry. Subsequent access to the roaming network list accurately and timely identifies the roaming arrangements that are permitted of a mobile node associated with a particular home network, with other networks.

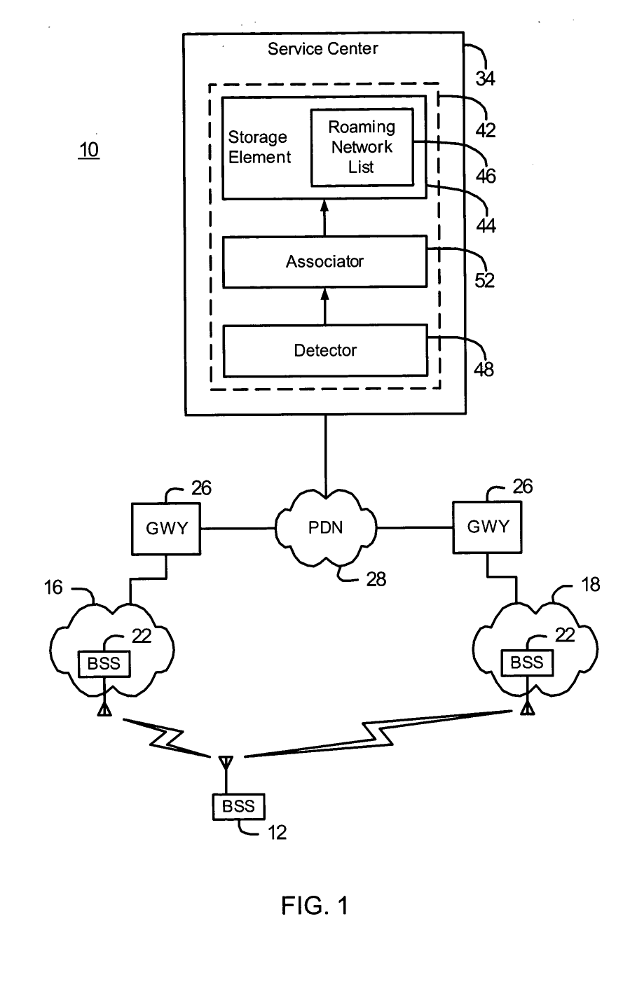

Referring now to FIG. 1, a radio communication system, shown generally at 10, provides for radio communications between a radio network and mobile nodes, of which the mobile node (MN) 12 is representative. The communication system is a multi-user communication system, and a plurality of concurrent communication sessions are concurrently effectuable between the radio network and a plurality of mobile nodes. During the communication session, communication services are effectuated. While only the single, representative mobile node 12 is shown in the Figure, additional mobile nodes can analogously be represented in the Figure.

In the exemplary implementation, the radio communication system forms a cellular communication system that operates, generally, pursuant to the operating protocols set forth in the operating specification of the GSM (Global System for Mobile communications) cellular communication system promulgated by the ETSI. The system further provides for GPRS (General Packet Radio Service) that is also effectuated pursuant to an operating specification related thereto, and promulgated by the ETSI. While the following description of exemplary operation of the communication system 10 shall be described with respect to its exemplary implementation as a GSM/GPRS system, the teaching of the present invention are analogously also implementable in other types of cellular, and other radio, communication systems. Operation of an embodiment of the present invention can analogously also be described with respect to its implementation in other types of communication systems.

Communications between the mobile node and the network part of the communication system are effectuated upon radio channels defined by a radio air interface extending therebetween. Various channels are defined upon radio links formed between the network part and the mobile, including, for instance, channels used for communication of control data and traffic data.

The network part of the communication network includes a plurality of different networks, each operated by a network operator. Here, two networks, networks 16 and 18 are shown in the Figure. The network 16 here forms the home network of the mobile node 12, and the network 18 forms a network encompassing a geographic area to which the mobile node is capable of roaming. And, here, the networks 16 and 18 are operated by different network operators.

Both the network 16 and the network 18 form GSM/GPRS-compliant networks. And, each of the networks 16 and 18 includes the functional entities that are defined in the ETSI-promulgated, operational specification pertaining to GSM/GPRS. Accordingly, the network 16 includes a base station system (BSS) 22. The base station system includes both a radio transceiver and also control entities that control operation of the radio transceiver. A single base station system 22 is shown in the Figure. In a typical system, each base station system typically includes a plurality of base transceiver stations, and the network also includes a plurality of base station systems. Each base station transceiver, formed of a radio transceiver, defines a portion, referred to as a cell, of a geographical area encompassed by the network. When a mobile node is positioned within a cell defined by one of the radio transceivers, the mobile node generally communicates with the associated radio transceiver.

A base station system, commonly referenced at 22, is also embodied at the second network 18. Base transceiver stations of the base station system of the second network also define cells.

The network 16 is coupled, by way of a gateway (GWY) 26 to a packet data network (PDN) 28. The packet data network is representative of, e.g., the internet backbone. And, the second network 18 is also coupled to the packet data network 28 by way of a gateway 26.

A service center 34 is coupled to the packet data network 28 and is here representative of a service center that is associated with the communication of data pursuant to effectuation of a GPRS communication.

As noted previously, due to the inherent mobility of the mobile node 12, the mobile node might roam beyond its home network, i.e., here meaning the network controlled by the home operator of the mobile station, into a network operated by another operator. When roaming into the area encompassed by the other network, continued operation of the mobile station requires, amongst other things, that the respective network operators have a roaming agreement permitting continued operation of the mobile station when the mobile station roams into the area encompassed by the network operated by the other network operator. The network 18 is here representative of such other network, and movement of the mobile station 12 out of the area encompassed by the network 16 and into the area encompassed by the network 18 is representative of the network into which the mobile node roams.

For planning purposes, a user of the mobile node, knowing that the mobile node shall roam beyond the home network of the mobile node, would like to know whether a roaming agreement between the operator of the home network and the network at which the user and the mobile node exists. Conventional notification schemes include posting on a website, maintained by the operator of the home network associated with the mobile node, of other networks with which the network operator has roaming agreements. However, information posted on such websites is sometimes obsolete and does not, therefore, provide accurate information to the user of the mobile node to be used for planning purposes.

The service center 34 includes apparatus, shown generally at 42, of an embodiment of the present invention that facilitates formation of a roaming network list, accessible by a user of the mobile node to provide a user of the mobile node with an accurate listing of networks with which the mobile node can communicate when roaming beyond the home network of the mobile node.

The apparatus includes a storage element 44 at which the roaming network list 46 is maintained. The apparatus includes a detector 48 that is coupled to receive positional and identifying indicia associated with the mobile node 12.

Detections made by the detector 48 are provided to an associator 52. The associator 52 associates the positioning of the mobile node 12 together with the network through which the mobile node is communicating. For instance, when the mobile node 12 is positioned to communicate with the network 18, the positional information is associated by the associator 52 to identify that the network 18 is a suitable roaming network with which the operator of the home network 16 has an operating agreement. Asssociations made by the associator 52 are provided to the storage element 44. And, values of the associations made by the associator 52 form the entries to the roaming network list 46. Time indicia are also associated with the entries placed in the roaming network list. When the information becomes dated, i.e., is stored at the roaming network list for greater than a selected time period, the entry is deleted, or otherwise given lesser weight than other entries. The associator 52, in one implementation, also operates as a deleter for deleting time-expired entries. Thereby, dynamic selection and dynamic updating of the entries to the roaming network list better ensures that the networks indicated to be suitable for communications with a particular mobile node when roaming beyond the home network of the mobile node. The user of the mobile node planning to travel beyond the home network of the mobile node accesses the roaming network list, accessible, e.g., by way of the internet or through download to the mobile node. Responsive to the indications provided on the roaming network list, a user of another mobile node is able to determine whether roaming capabilities shall be available when the user travels to the area encompassed by the other network.

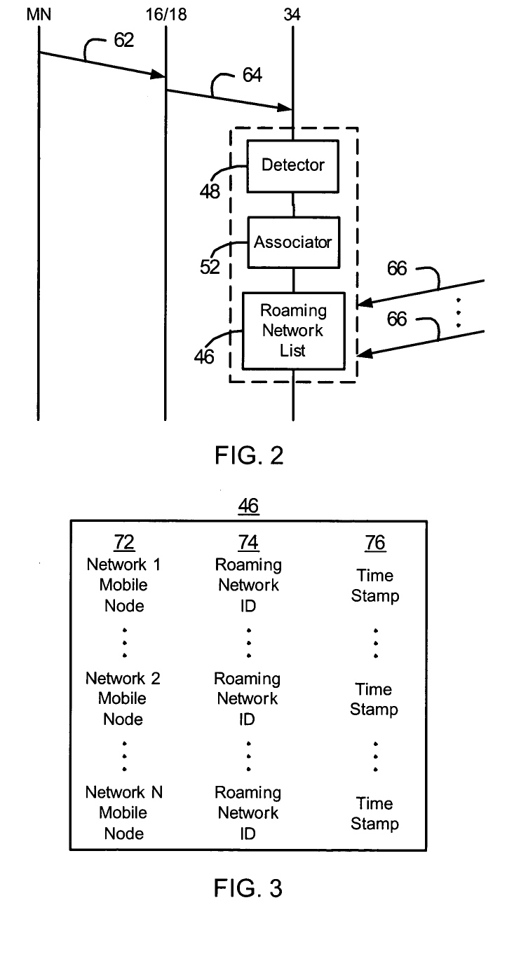

FIG. 2 illustrates a message sequence diagram, shown generally at 60, representative of operation of an embodiment of the present invention. Here, the mobile node sends identifying indicia, here indicated by the segment 62, to the network within which the mobile node is positioned and is operable. The identifying indicia is formed of, in the exemplary implementation, the IMSI (International Mobile Subscriber Identity) number associated with the mobile node. The IMSI number includes the MNC (Mobile Network Code) and the MCC (Mobile Country Code) as portions thereof. The identifying indicia is provided pursuant to registration procedures or, in one implementation, as part of message header information of every message that is communicated by the mobile node.

When the network receives the identifying indicia, such information is forwarded, indicated by the segment 64, to the service center 34. Once delivered to the service center, the detector 48 detects its delivery, and indications are provided to the associator 52. And, thereafter, once the associations are made, the roaming network list is populated with values determined by the associations. Subsequently, and as indicated by the segments 66, access is made to the contents of the roaming network list to provide other users with indications of the roaming arrangements between different network operators.

The roaming network list is created based upon indicia provided by a large number of mobile nodes accessing any of various networks to create an exhaustive roaming network list, dynamically created and dynamically altered, thereby to be in updated form, more likely to be accurate than conventional manners by which roaming network lists are created.

FIG. 3 illustrates an exemplary network roaming list 46 that is constructed through operation of the apparatus 42. Here, a first column 72 indicates mobile nodes, identified at least in terms of their respective home networks. Indexed thereagainst are roaming network identities 74 at which the mobile nodes associated therewith are operable. And, time stamp information 76 is also contained in each entry of the roaming network list.

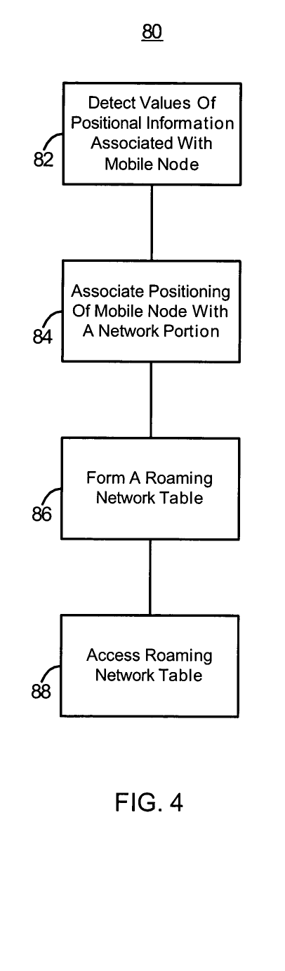

FIG. 4 illustrates a method flow diagram, shown generally at 80, representative of operation of an embodiment of the present invention. The method facilitates communication of a mobile node when roaming beyond a home network portion associated therewith.

First, and as indicated by the block 82, values of positional information associated with a mobile node is detected. Then, and as indicated by the block 84, positioning of the mobile node is associated together with one of the network portions of the communication system to which the positional information is communicated, thereby to indicate if one of the network portions with which the positioning information is communicated indicates the mobile node to be associated is other than the home network portion associated with the mobile node.

Then, and as indicated by the block 86, a roaming network table is formed that indicates with which of the network portions that the mobile node is capable of communicating. Thereafter, and as indicated by the block 88, the roaming network table is accessed to provide one accessing the table with an indication of roaming arrangements between the respective networks of the communication system.

Thereby, a dynamically-created roaming network list is formed, and updated, as appropriate. Access to the roaming network list provides an accurate indication to the one accessing the list of the roaming arrangements between different networks of a radio communication system.

The previous descriptions are of preferred examples for implementing the invention, and the scope of the invention should not necessarily be limited by this description. The scope of the present invention is defined by the following claims.

1. In a radio communication system having at least a first mobile node operable to communicate with a network part, the network part having a first network portion and at least a second network portion, the first network portion operated by a first network operator and the at least the second network portion operated by at least a second network operator, a selected one of the first network portion and the at least the second network portion forming a home-network portion associated with the mobile node, an improvement of apparatus for facilitating communication of the mobile node when roaming beyond the home-network portion associated therewith, said apparatus comprising:
a detector adapted to receive positional information associated with the mobile node, the positional information communicated by the mobile node to the network part at selected times when the mobile node communicates with the network part, said detector for detecting values of the positional information and for forming indications of the values of the positional information;
an associator coupled to said detector to receive the indications formed by said detector of the values of the positional information, said associator for associating positioning of the mobile node together with one of the first and at least second network portions, respectively, to which the positional information is communicated, thereby to indicate, if the one of the network portions, with which the positioning information indicates the mobile node to be associated, is other than the home-network portion; and
a storage element coupled to said associator, said storage element for storing values representative of associations formed by said associator, the values together forming a roaming network table indicating with which of the network portions the mobile node is capable of communicating.

2. The apparatus of claim 1 wherein the mobile node has an identifier associated therewith and wherein said detector is further adapted to receive the identifier and for detecting values thereof.

3. The apparatus of claim 2 wherein the radio communication system comprises a cellular radio communication system that provides for GPRS (General Packet Radio Service) and wherein the identifer associated with the mobile node comprises at least a portion of an IMSI (International Mobile Subscriber Identity) number.

4. The apparatus of claim 3 wherein the IMSI number includes a Mobile Network Code (MNC) and wherein the at least the portion of the IMSI number of which said detector detects the values comprises the Mobile Network Code, the Mobile Network Code identifying the home network portion associated with the mobile node.

5. The apparatus of claim 3 wherein the IMSI number includes a Mobile Country Code (MCC) and wherein the at least the portion of the IMSI number of which said detector detects the values comprises the Mobile Country Code.

6. The apparatus of claim 1 wherein the mobile node registers with the network part at selected times and wherein the positional information detected by said detector is communicated by the mobile node pursuant to registration with the network part.

7. The apparatus of claim 1 wherein communications of the mobile node are formatted into messages, the messages having header parts, and wherein the positional information detected by said detector is embodied in the header parts of the messages.

8. The apparatus of claim 2 wherein said associator further identifies the mobile node whose positioning is associated together with the one of the first and at least second network portions.

9. The apparatus of claim 1 wherein the roaming network table further includes an indication of a time at which the values representative of the associations are stored at said storage element.

10. The apparatus of claim 9 further comprising a roaming table entry deleter coupled to said storage element, said roaming table entry deleter selectably operable to delete selected values of the roaming entry table maintained at said storage element.

11. The apparatus of claim 10 wherein said roaming table entry deleter deletes values of the roaming entry table stored thereat for longer than a selected time period.

12. The apparatus of claim 1 wherein the radio communication system comprises a multi-user system, wherein the at least the first mobile node comprises a plurality of mobile nodes, wherein said detector detects communications of any of the plurality of the mobile nodes, wherein said associator associates positioning of any of the plurality of mobile nodes, and wherein the roaming network table formed at said storage element includes values associated with any of the plurality of mobile nodes.

13. In a method of communicating in a radio communication system having at least a first mobile node operable to communicate with a network part, the network part having a first network portion and at least a second network portion, the first network portion operated by a first network operator and the at least the second network portion operated by at least a second network operator, a selected one of the first network portion and the at least the second network portion forming a home-network portion associated with the mobile node, an improvement of a method for facilitating communication of the mobile node when roaming beyond the home-network portion associated therewith, said method comprising:
detecting values of positional information, the positional information associated with the mobile node and communicated by the mobile node to the network part at selected times when the mobile node communicates with the network part;
associating positioning of the mobile node together with one of the first and at least second network portions, respectively, to which the positional information is communicated, thereby to indicate, if the one of the network portions with which the positioning information indicates the mobile node to be associated, is other than the home network portion; and
forming a roaming network table indicating with which of the network portions that the mobile node is capable of communicating responsive to associations formed during said operation of associating.

14. The method of claim 13 wherein said operation of detecting further comprises detecting values that identify the mobile node.

15. The method of claim 14 wherein the radio communication system comprises a cellular radio communication system that provides for GPRS (General Packet Radio Service) and wherein the values that identify the mobile node during said operation of detecting comprise at least a portion of an IMSI (International Mobile Subscriber Identity) number.

16. The method of claim 15 wherein the at least the portion of the IMSI number comprises a mobile network code, the mobile network code identifying the home network portion associated with the mobile node.

17. The method of claim 15 wherein the at least the portion of the IMSI number comprises a mobile country code.

18. The method of claim 15 wherein said operation of forming the roaming table further comprises identifying times at which values are entered thereat.

19. The method of claim 18 further comprising the operations of accessing the roaming network table and determining in which of the first and at least second network portions that the mobile node, associated with the home network portion, can communicate when roaming beyond the home-network portion.

20. The method of claim 19 further comprising the operation of deleting values out of the roaming network table after a selected time.
